(19) United States
(12) Patent Application Publication
(10) Pub. No.: US 2025/0125852 A1
(43) Pub. Date: Apr. 17, 2025

(54) ZONE-SPECIFIC MACHINE LEARNING FOR MIMO COMMUNICATION SYSTEMS

(71) Applicant: ARIZONA BOARD OF REGENTS ON BEHALF OF ARIZONA STATE UNIVERSITY, Scottsdale, AZ (US)

(72) Inventors: Ahmed ALKHATEEB, Chandler, AZ (US); Yu ZHANG, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/912,922

(22) Filed: Oct. 11, 2024

Related U.S. Application Data
(60) Provisional application No. 63/590,048, filed on Oct. 13, 2023.

(51) Int. Cl. H04B 7/06; H04W 24/02

(52) U.S. Cl. CPC H04B 7/0626; H04W 24/02

(57) ABSTRACT

A system and method for training the machine learning models of the multiple-input multiple-output (MIMO) communication systems. The system and method cluster the training data based on the device position. Then, separate models are trained based on the data for each position. The system and method can be applied to the design of machine learning-based beamforming, precoding, channel compression, channel estimation, and codebook design among other applications. The system uses the implicit or explicit user position information to select the right zone-specific model and its parameters.

### CROSS REFERENCE TO RELATED APPLICATIONS

This application claims the benefit of U.S. Provisional Patent Application No. 63/590,048 filed on Oct. 13, 2023, the contents of which are hereby incorporated by reference in its entirety.

### GOVERNMENT RIGHTS

This invention was made with government support under grant/contract #1923676 awarded by the National Science Foundation. The government has certain rights in the invention.

### FIELD OF THE DISCLOSURE

The present disclosure relates to a zone-specific feedback process for training machine learning models of the multiple-input multiple-output (MIMO) communication systems.

### BACKGROUND

Massive MIMO systems rely on accurate channel state information (CSI) to achieve beamforming and multiplexing. In frequency division duplexing (FDD) systems, the downlink (DL) CSI is estimated at the user equipment (UE) and then sent back to the base station (BS). Some CSI feedback schemes are not scalable to systems with large numbers of antennas due to the excessive feedback overhead. Deep learning based CSI feedback use is limited because of large channel variations in a given site, and efficiency concerns with using a single deep learning model with reasonable complexity. Prior work has extended the results of using deep learning based CSI feedback by using complex/advanced deep learning models and by developing practical networks. The costs are not measured comprehensively by accounting for various types of overhead. When the channel samples from the site are processed without fully leveraging the underlying channel distributions, channel samples can have a low compression rate and high feedback overhead, or high model complexity to improve the CSI recovery accuracy.

What is needed is zone-specific CSI feedback to achieve improved performance with reduced overall operating expenses.

### SUMMARY

A system of one or more computers can be configured to perform zone-specific CSI feedback to generalize a site-specific framework. The site space is divided into multiple channel zones, different CSI models are used at each zone, and the channel samples are processed. Multiple CSI models at different zones improve the learning of diversified channel distributions, and enable flexible design/deployment. The selection of the zone leverages the situation awareness of the device/user either explicitly using the position information, or implicitly using the CSI models. Metrics referred to herein as model parameter transmission and update rate are used to evaluate and optimize the overhead associated with the deep learning-based CSI feedback in practical systems/deployments. Simulation results based on ray-tracing scenario are used to compute the gains of a system in accordance with embodiments of the present disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for compressing and recovering channel information between edge equipment and a base station. The method includes partitioning a wireless environment into one or more channel zones, and decomposing a channel state information (CSI) feedback network into a plurality of subnetwork models. The plurality of subnetwork models compress and recover channels from the one or more channel zones. Each of the plurality of subnetwork models has a CSI encoder, and each of the plurality of subnetwork models includes one or more model parameters. The method also includes training the plurality of subnetwork models for the one or more channel zones forming a composite CSI feedback model, and compressing and recovering the channel information between the edge equipment and the base station based on the composite CSI feedback model. Other embodiments of this aspect include corresponding computer systems, apparatus, and computer programs recorded on one or more computer storage devices, each configured to perform the actions of the methods.

Implementations may include one or more of the following features. The method may include determining a position of the edge equipment, collecting a downlink channel dataset, and clustering the downlink channel dataset into the one or more channel zones based on the position. The method may include determining a number of times the edge equipment switches from one of the one or more channel zones to another of the one or more channel zones within a pre-selected time interval, computing model parameters transmission rate (MPTR) as an average rate that the one or more model parameters are downloaded per pre-selected period of time to the edge equipment, computing model parameters update rate (MPUR) as a frequency that the edge equipment updates or switches the CSI encoder based at least on movement of the edge equipment, and computing channel recovery error and feedback overhead based on a ratio of MPTR to MPUR. The training may include jointly training the CSI encoder and a decoder, training multiple of the CSI encoders per decoder, and/or training multiple decoders and the CSI encoders for the one or more channel zones. Multiple of the one or more channel zones share a decoder or the CSI encoder. The one or more channel zones are non-overlapping. The method may include accessing positions of the edge equipment from a network or cloud, and clustering the edge equipment into the one or more channel zones based on the positions. The training may include training the plurality of subnetwork models based on an end-to-end learning approach and a mean square error loss function. The one or more model parameters differ between each of the plurality of subnetwork models. The one or more channel zones may include one or more clusters of scatterers. Partitioning the wireless environment may include clustering data about characteristics of edge equipment, and partitioning the edge equipment into the one or more channel zones based at least on the characteristics. The characteristics may include one or more of a position of the edge equipment, signal quality in the one or more channel zones, channel statistics in the one or more channel zones, or the wireless environment in the one or more channel zones. The edge equipment may include cellular devices. The one or more channel zones may include one or more spatial zones. Implementations of the described techniques may include hardware, a method or process, or computer software on a computer-accessible medium.

One general aspect includes a computing system for compressing and recovering channel information between edge equipment and a base station. The computing system includes one or more processors, and a memory system may include one or more non-transitory computer-readable media storing instructions that, when executed by at least one of the one or more processors, cause the computing system to perform operations. The operations may include partitioning a wireless environment into one or more channel zones, and decomposing a channel state information (CSI) feedback network into a plurality of subnetwork models. The plurality of subnetwork models compress and recover channels from the one or more channel zones, each of the plurality of subnetwork models has a CSI encoder, and each of the plurality of subnetwork models includes one or more model parameters. The operations also include training the plurality of subnetwork models the one or more channel zones forming a composite CSI feedback model, and compressing and recovering the channel information between the edge equipment and the base station based on the composite CSI feedback model. Other embodiments of this aspect include corresponding computer systems, apparatus, and computer programs recorded on one or more computer storage devices, each configured to perform the actions of the methods.

Implementations may include one or more of the following features. The computing system where the operations further may include determining a position of the edge equipment, collecting a downlink channel dataset, and clustering the downlink channel dataset into the one or more channel zones based on the position. Implementations of the described techniques may include hardware, a method or process, or computer software on a computer-accessible medium.

One general aspect includes a non-transitory computer-readable medium storing instructions for compressing and recovering channel information between edge equipment and a base station that, when executed by one or more processors of a computing system, cause the computing system to perform operations. The operations include partitioning a wireless environment into one or more channel zones, and decomposing a CSI feedback network into a plurality of subnetwork models. The plurality of subnetwork models compress and recover channels from the one or more channel zones. Each of the plurality of subnetwork models having a CSI encoder, and each of the plurality of subnetwork models includes one or more model parameters. The operations also include training the plurality of subnetwork models the one or more channel zones forming a composite CSI feedback model, and compressing and recovering the channel information between the edge equipment and the base station based on the composite CSI feedback model. Other embodiments of this aspect include corresponding computer systems, apparatus, and computer programs recorded on one or more computer storage devices, each configured to perform the actions of the methods.

Implementations may include one or more of the following features. The operations further may include determining a position of the edge equipment, collecting a downlink channel dataset, and clustering the downlink channel dataset into the one or more channel zones based on the position. Implementations of the described techniques may include hardware, a method or process, or computer software on a computer-accessible medium.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a pictorial illustration of a zone-specific CSI feedback approach where different deep learning weights are learned for each zone;

FIG. 2 is a pictorial illustration of spatial zones in an outdoor scenario;

FIG. 3 is a graphical illustration of normalized mean square error (NMSE) performance with three different methods that have different neural network complexities, with compression rate of 1/64;

FIG. 4, is a schematic block diagram of the components of a system in accordance with embodiments of the present disclosure; and

FIG. 5 is a method in accordance with embodiments of the present disclosure.

### DETAILED DESCRIPTION

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

The following description of various typical aspect(s) is merely descriptive in nature and is in no way intended to limit the disclosure, its application, or uses. As used throughout this disclosure, ranges are used as shorthand for describing each and every value that is within the range. It should be appreciated and understood that the description in a range format is merely for convenience and brevity, and should not be construed as an inflexible limitation on the scope of any embodiments or implementations disclosed herein. Accordingly, the disclosed range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive) of that numeral, ±0.1% (inclusive) of that numeral, ±0.5% (inclusive) of that numeral, ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

In some configurations, a method in accordance with embodiments of the present disclosure for compressing and recovering channel information includes the steps of accessing, by the UE, one or more channels in a zone associated with the UE, compressing, by the UE, the channels based on a trained encoder model, and sending, by the UE, the compressed channels to the BS. Feedback overhead is lower when the channel information is compressed than when the channel information is not compressed. The method further includes reconstructing (decoding), by the BS, the one or more channels from the compressed channel information, using a trained decoder model, and using the decoded channel(s) to communicate with the UE. The method can use frequency division duplexing (FDD) massive multiple input multiple output (MIMO) systems where a base station (BS) with Nₜ antennas is communicating with a single-antenna UE. The system can include an orthogonal frequency-division multiplexing (OFDM) digital transmission technique with a K subcarriers. In some configurations, channels between the BS and the UE are clustered into zones, and, for each zone, and encoder and decoder are trained. In some configurations, channels in the zone are compressed by the UE and sent to the BS, thus reducing the channel feedback overhead. In some configurations, the zones are configured by grouping UEs according to a detected UE position. In some configurations, the zones are configured in pre-selected groupings or user-entered groupings. Several UEs can share an encoder/decoder pair. In some configurations, the UE can use a single encoder for the full site, or a different encoder for each zone. The BS can accommodate a single encoder or multiple encoders. In some configurations, multiple encoders can be trained using a single decoder. In some configurations, a model executing on the BS is trained for multiple decoders and for multiple zones, thus improving decoding efficiency and channel reconstruction accuracy. Training can occur during operational periods, thus further improving the quality of the result. In some configurations, joint training occurs between the UE and the BS, using various configurations such as, for example, but not limited to, one encoder for several decoders, one decoder for several zones, multiple encoders for multiple decoders, and an encoder for each decoder.

In the downlink, the received signal at the k-th subcarrier is given by

$${y}_{k} = {\overline{h}}_{k}^{H} {f}_{k} {x}_{k} + {z}_{k} , \qquad ( 1 )$$

where h̅ₖ∈ [symbol] ^{N}^{ₜ}^{×1}, fₖ∈ [symbol] ^{N}^{ₜ}^{×1}, xₖ∈ [symbol] , and zₖ∈ [symbol] are the channel vector between the BS's antenna array and the UE's antenna, BS transmit beamforming, transmitted complex symbol, and the noise sample at the k-th subcarrier. The transmit beamforming fₖ at the BS uses the knowledge about the channel vector h̅ₖ. For that, the BS relies on the CSI feedback from the UE to determine fₖ. For example, in the 5G new radio (NR), CSI-reference signal (RS) transmitted by the BS is used by the UE to estimate the downlink (DL) channel, after which Type I/II codebooks are used by the UE to send the CSI back to schedule the DL data transmission. The estimated channels across the subcarriers are denoted as H̅=[h̅₁, . . . , h̅_{K}].

A geometric channel model for h̅ₖ with Lₖ paths is adopted. Each path l has a complex gain [symbol] and an angle of departure (AoD) [symbol] . The channel vector can be expressed as

$${\overline{h}}_{k} = {\sum }_{ℓ = 1}^{{L}_{k}} {α}_{k}^{( ℓ )} a ( {ϕ}_{k}^{( ℓ )} ) , ∀ k = 1 , … , K , \qquad ( 2 )$$

where a(.) denotes the BS array response vector.

Channel compression and recovery for the massive MIMO CSI feedback are evaluated and feedback overhead is reduced. The original channel matrix H̅ is transformed to the angular-delay domain using a 2D discrete Fourier transform (DFT)

$$H = {F}_{a} \overline{H} {F}_{d}^{H} , \qquad ( 3 )$$

where Fₐ and F_{d} are Nₜ×Nₜ and K×K DFT matrices, respectively. The UE compresses the transformed channel matrix H into a codeword using a channel encoder

$$s = {f}_{e n} ( H ) , \qquad ( 4 )$$

where s∈ [symbol] ^{L} is a length-L codeword. The compression rate (CR), denoted as γ, achieved by the channel compression scheme is defined as

$$γ = \frac{L}{2 \times {N}_{t} \times {N}_{c}} .$$

The codeword s is reported to the BS through a feedback link. The BS decompresses the encoded information (i.e., s) using a channel decoder to recover the original channel vectors, i.e., H, which can be expressed as

$$\hat{H} = {f}_{d e} ( s ) . \qquad ( 5 )$$

When the channel encoder and decoder are parameterized for deep learning models, the channel recovery error for a given channel distribution under CR γ is minimized.

$${min}_{Θ} {𝔼}_{H} [ {‖ H - {f}_{d e} ( {f}_{e n} ( H ; {Θ}_{e n} ) ; {Θ}_{d e} ) ‖}^{2} ] , \qquad ( 6 )$$

where Θ={Θₑₙ, Θ_{de}} denotes the parameters of the model.

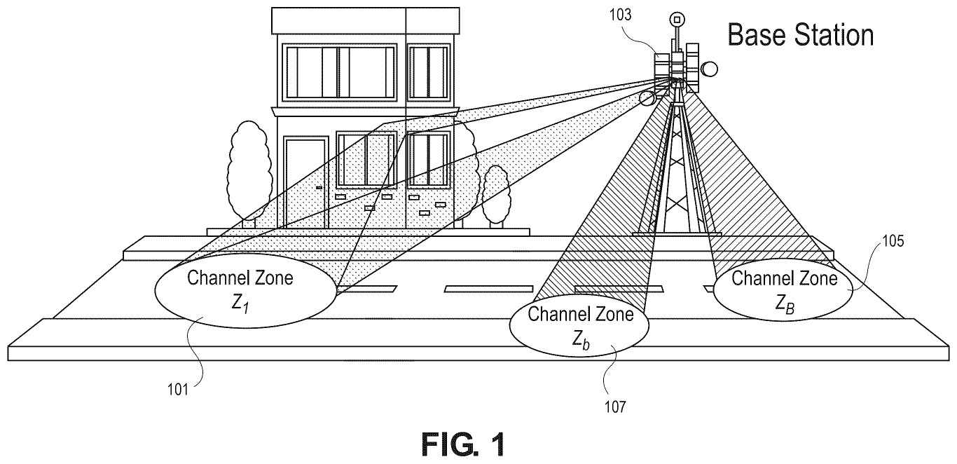

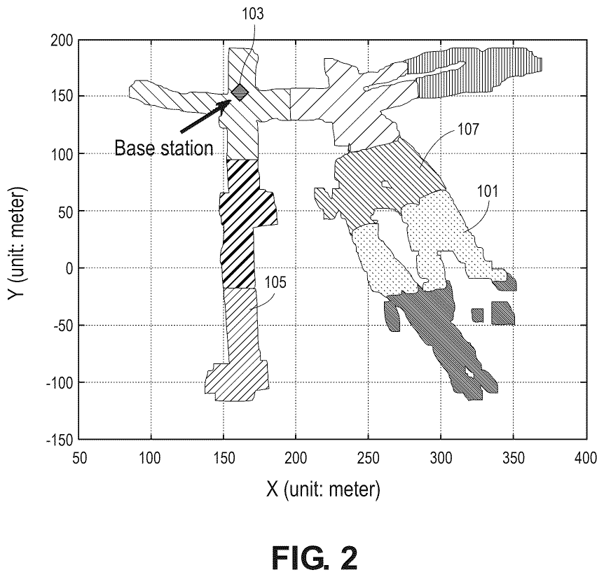

Referring now to FIGS. 1 and 2, different UE groups might experience different channel characteristics due to the surrounding environments. The distribution information is used to improve channel recovery accuracy. For deep learning-based CSI feedback, zone-specific CSI feedback is used to reduce feedback overhead. As illustrated in FIG. 1, different sectors 101, 105, 107 of the site tend to experience distinct channel distributions due to their own local propagation conditions. The channel model can be a wireless environment partitioned into clusters of scatterers, where one or more clusters represents a zone from the BS's 103 perspective, as illustrated in FIG. 1, henceforth referred to as a channel zone Z_{b} 107, where b is the zone index.

Using a Karhunen-Loève representation, one possible way for defining the zones is by expressing the channels of the users in each zone as

$$h = {V}_{{z}_{b}} {Λ}_{{z}_{b}}^{1 / 2} {w}_{{z}_{b}} , ∀ h ∈ {𝒵}_{b} , \qquad ( 7 )$$

where Λ_{z}_{_{b}}∈ [symbol] ^{r}^{_{b}}^{×r}^{_{b}} is a diagonal matrix with r_{b} positive values occupying its diagonal. V_{z}_{_{b}}∈ [symbol] ^{KN}^{ₜ}^{×r}^{_{b}} is a sub-unitary matrix, i.e., V_{z}_{_{b}}^{H}V_{z}_{_{b}}=Iᵣ_{_{b}}. w_{z}_{_{b}}∈ [symbol] ^{r}^{_{b}}^{×1} is modeled as a random vector that is drawn from [symbol] (0, Iᵣ_{_{b}}). The channels from the zone Z_{b} can be viewed as being sampled from a channel subspace spanned by V_{z}_{_{b}}Λ_{z}_{_{b}}^{1/2}.

The variation of the channel in a specific zone is much smaller than that in the site. The reduction in the channel variation makes it possible to achieve higher compression rate and/or better CSI recovery accuracy. The compression can be realized on a manifold that has much lower dimensionality, which lays the foundations for the reduction in the CSI feedback overhead. The single CSI feedback network is decomposed into multiple (i.e., B) subnetworks with focusing on compressing and recovering the channels in one of the zones.

$${f}^{( b )} ( {h}_{{z}_{b}} ) = {f}_{d e}^{( b )} ( {f}_{e n}^{( b )} ( {h}_{{z}_{b}} ; {Θ}_{e n}^{( b )} ) ; {Θ}_{d e}^{( b )} ) , ∀ b , \qquad ( 8 )$$

where h_{z}_{_{b}} indicates that the channel sample is from the channel zone Z_{b}. In some configurations, subnetworks have the same model architecture as each other, where their parameters differ. For the bₜₕ subnetwork, the parameter is Θ^{(b)}={Θₑₙ^{(b)}, Θ_{de}^{(B)}}. The subnetworks' parameters constitute the parameters of a composite model, i.e., Θ={Θ⁽¹⁾, . . . , Θ^{(B)}}. The problem can be stated as

$${min}_{{\{ {Θ}^{( b )} \}}_{b = 1}^{B}} {𝔼}_{h} [ {min}_{b} {‖ {f}^{( b )} ( h ; {Θ}^{( b )} ) - h ‖}^{2} ] . \qquad ( 9 )$$

The subnetwork, f^{(b)}, is independently trained with a given dataset.

The model is trained by leveraging a downlink channel dataset, denoted as [symbol] ={h₁, . . . , h_{U}}, which is collected by the system. By applying channel clustering, the original channel dataset can be partitioned into B non-overlapping channel subsets, expressed as

$$ℋ = {ℋ}^{( 1 )} ⋃ … ⋃ {ℋ}^{( B )} , \qquad ( 10 )$$

where [symbol] ^{(b)}∩ [symbol] ^{(b′)}=∅, ∀b≠b′ and ∀b,b′∈{1, . . . , B}. There are B subnetworks trained on one channel subset. An end-to-end learning approach is used, and the mean squared error (MSE) loss function is used for training the model.

$${ℒ}_{{Θ}^{( b )}} = \frac{1}{\vert {ℋ}^{( b )} \vert} {\sum }_{h ∈ {ℋ}^{( b )}} {‖ h - {f}^{( b )} ( h ; {Θ}^{( b )} ) ‖}^{2} , ∀ b . \qquad ( 11 )$$

The B trained subnetworks collectively constitute the composite CSI feedback model.

The performance metrics, model parameters transmission rate (MPTR) and model parameters update rate (MPUR) are used as performance indicators to measure the overheads of different deep learning-based CSI feedback solutions. Sites have multiple CSI encoders that the UE devices load and use instead of the compression codebook (e.g. Type I/II codebooks, etc.) which is known before the actual deployment. The MPTR and MPUR are defined using a spatial zone S_{b} which is the counterpart of the channel zone Z_{b} in the spatial domain, and it can be defined by finding a set of positions where their corresponding channels are within the same channel zone, that is

$${𝒮}_{b} = \{ x \vert g ( x ) = h , ∀ h ∈ {𝒵}_{b} \} , ∀ b ∈ \{ 1 , … , B \} , \qquad ( 12 )$$

where g(.) denotes the mapping function from position to channel. Equation (12) implies that the cell space, denoted as S, can be partitioned into non-overlapping spatial zones, that is,

$$𝒮 = {⋃}_{b = 1}^{B} {𝒮}_{b} .$$

For a CSI feedback method that includes multiple channel encoders, the overhead is related to the UE mobility pattern that triggers the model update. For any given UE, the mobility pattern is a realization of a random process [symbol] (t), and different UEs' mobility patterns are independent realizations of [symbol] (t). By leveraging a discretized time series [symbol] ={t₁, . . . , t_{P}}, where t₁< . . . <t_{P}, the number of times of (spatial) zone switching within a time horizon (i.e., t_{P}−t₁) as

$${N}_{Z S} = {𝔼}_{ℳ} [ {\sum }_{p = 1}^{P - 1} \{ ℳ ( {t}_{p} ) ∈ {𝒮}_{b} and ℳ ( {t}_{p + 1} ) ∈ {𝒮}_{b}^{′} \} ] ,$$

where [symbol] (·) is the indicator function and b≠b′. The rate of the zone switching is

$${r}_{zs} = \frac{{N}_{zs}}{{t}_{P} - {t}_{1}} .$$

MPTR is the average rate with which the model parameters are downloaded in the UE device. MPTR is the unit of number of parameters per second. MPUR is the frequency with which a UE device updates/switches its CSI encoder due to mobility. MPTR allows the system to analyze the over-the-air overhead, in addition to the CSI feedback overhead, of a proposed deep learning-based CSI acquisition solution. MPUR characterizes the local behavior/overhead of a solution inside the UE device. These metrics enable the evaluation of the practicality of a solution under given scenarios given that the channel encoder is expected to be frequently updated at the UE side. Updating a model includes updating the encoder parameters. Downloading a model includes downloading a CSI encoder from the BS into the UE device, which incurs the over-the-air overhead. In some configurations, model update is triggered by zone switching. MPUR, denoted as rₘᵤ, is the same rate as the zone switching rate, i.e., rₘᵤ=r_{zs}. The model downloading rate, denoted as r_{md}, satisfies r_{md}≤rₘᵤ. If the UE device can download the subnetworks at once, no model downloading happens when the UE changes zones. If the CSI encoder in each subnetwork has V parameters, the MPTR of a specific method is equal to Vr_{md}. When r_{md}=rₘᵤ, i.e., the UE device can store one CSI encoder at a time, the MPTR is Vrₘᵤ.

In some configurations, the UE position information is available to the network or to the cloud where channel clustering is performed. Clustering the channels into channel zones can be based on partitioning the UEs based on their positions. The spatial proximity can imply correlations in the channels, and partitioning UEs based on positions can reduce the channel zone switching rate, which can lead to a reduced MPTR/MPUR. An augmented channel dataset that includes such information is [symbol] _{aug} {{(h₁, x₁), . . . , (h_{U}, x_{U})}, where a sample includes the UE channel and its position.

The training process includes UE clustering and network training. In some configurations, the clustering is based on position data. The set S of the user positions in the cell is partitioned into B spatial zones. Based on these zones, the channels can be partitioned correspondingly, for example, based on geometry, such as a uniform partition of the space. B subnetworks are trained based on the different channel subsets. The training results include a position classifier and a collection of subnetworks. In operation, the BS and the UE can select the subnetwork that corresponds to the current spatial zone based on the position information. A trained position classifier can be used to obtain the spatial zone information.

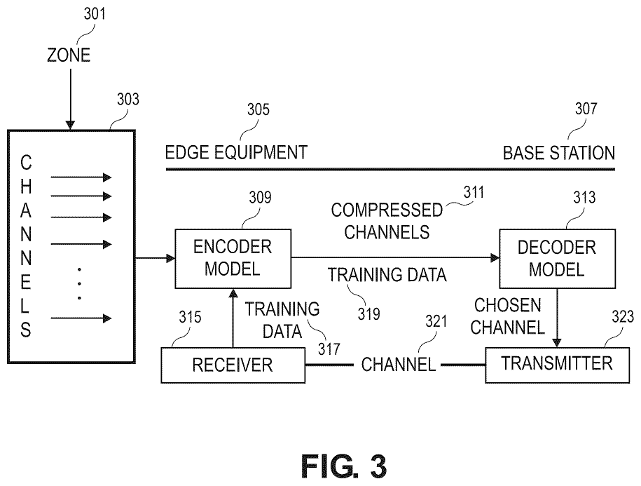

Referring now to FIG. 3, a system in accordance with embodiments of the present disclosure includes edge (for example, but not limited to, user) equipment 305 and a base station 307. The edge equipment 305 uses a channel 321 to communicate with the base station 307. Possible channels 303 that the edge equipment 305 can use to communication are clustered into zones 301 as described herein. The clustered channels are encoded by a trained encoder model 309 and compressed to reduce communications overhead. The compressed channels 311 are provided to a trained decoder mode 313 in the base station 307. The trained decoder model 313 determines a chosen channel 321 to use to communicate with the edge equipment 305. Data are sent to/from the transmitter 323 in the base station 307 to the receiver 315 in the edge equipment. When the edge equipment 305 moves out of the zone 301, a zone 301 can be determined, and encoder and decoder models can be determined. It is possible that movement of the edge equipment 305 will not result in a change of zone or change of either encoder or decoder model. It is also possible the movement of the edge equipment 305 will result in a zone change, and the new zone may be associated with a different trained encoder model 309 from the encoder model 309 of the previous location, and likewise with the trained decoder model 313. Further, it is possible that the trained encoder model 309 changes, and the trained decoder model 313 remains the same, or visa versa. Training updates can occur on the trained encoder model 309 and the trained decoder model 313, possibly using training data 317 and 319, respectively, that are gathered during operational use of the system.

To evaluate a system built in accordance with embodiments of the present disclosure, a scenario in which a BS is serving UEs in a downtown sector of a city can be used. In some configurations, the BS uses a 64-element (with 16-by-4 panel configuration) uniform planar array (UPA) operating at a carrier frequency of 3.5 GHz. Fifteen multi-paths of each BS-UE channel are considered. Based on these configurations, a total number of 105,996 UE channels are generated, out of which 24,000 samples are used for training the model and the remaining samples are for testing the model. A fully-connected layer based auto-encoder architecture as the CSI encoder and decoder networks is used. The details of the model architecture are shown in Table I, where β is a scaling factor that can change the model size.

TABLE I
CSI FEEDBACK MODEL PARAMETERS

| | | |
|---|---|---|
| Layer | Dimension | Parameters |

| | | | |
|---|---|---|---|
| Encoder | Fully-connected | (2NₜN_{c}, βL) | (2NₜN_{c} + 1)βL |
| | BatchNorm | (βL,) | 2βL |
| | Fully-connected | (βL, L) | (βL + 1)L |
| Decoder | Fully-connected | (L, βL) | (L+ 1)βL |
| | BatchNorm | (βL,) | 2βL |
| | Fully-connected | (βL, 2NₜN_{c}) | (βL + 1)2NₜN_{c} |

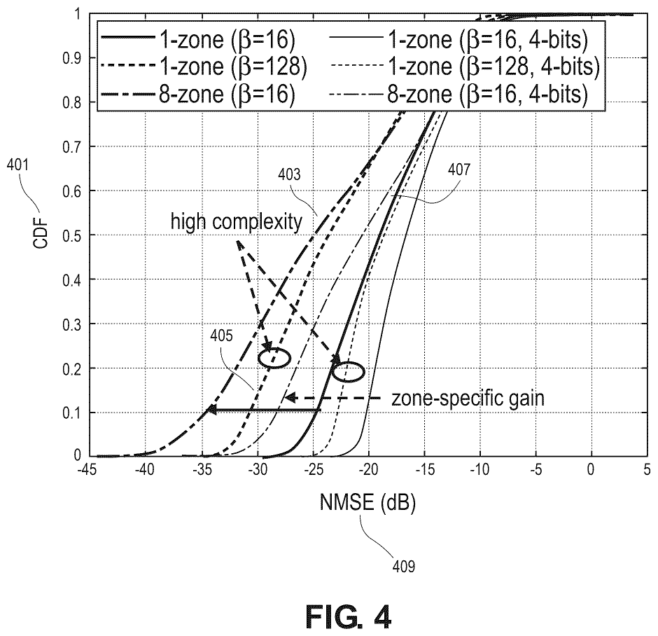

Referring now to FIG. 4, the CSI recovery accuracy with and without multiple channel zones, where these zones are generated based on the UE positions, is evaluated. The empirical cumulative distribution function (CDF) 401 of the achieved channel NMSE 409 accuracy is shown. The performance of three different models is compared, where two of them 405, 407 have a single CSI feedback network for the site, with two model sizes (i.e., β=16 and β=128). The third model 403 has 8 CSI feedback networks (8 zones) in which β=16. The total number of parameters of the networks is roughly the same as that of the network with β=128. For the evaluation described herein, the number of training samples does not vary with the number of partitioned zones and different model sizes. The compression rate is 1/64. Using channel zones, zone-specific CSI feedback provides improved performance over other options. For example, with the same model complexity, around 50% of the UEs have less than −25 dB NMSE when there are 8 channel zones. Around 8% of the UEs in the single zone case have less than −25 dB NMSE. Also, 50% of the users achieve more than 7 dB gain in their CSI NMSE performance. When comparing with the single-zone model that has 8 times higher complexity (β=128), the solution in accordance with embodiments of the present disclosure achieves improved performance.

UEs in accordance with embodiments of the present disclosure download a collection of CSI encoders from the BS or the cloud, and update the CSI encoder parameters whenever a model update is triggered, thus increasing the MPTR. To study the MPTR, considering that the CSI encoders are distributed to the UE devices, the trained network parameters of the encoder constitute over-the-air model transmission overhead. The CSI encoder network architecture in Table I is considered during this evaluation. In addition to the model size, the MPTR/MPUR depends on the model update rate rₘᵤ, which is based on the user mobility pattern. To estimate rₘᵤ, a time horizon of T seconds with the UE moving randomly within the cell space S under certain mobility is used, by which are counted the number of model updates, denoted as \hat{N}ₘᵤ. The model update rate is estimated as \hat{r}ₘᵤ=\hat{N}ₘᵤ/T, or equivalently, Tₘᵤ=T/\hat{N}ₘᵤ is the average time duration that the UE is using the same CSI encoder.

In Table II, the comparison results of the three models shown in FIG. 3 are indicated. For example, when a pedestrian is carrying a mobile device and randomly walking around the region, a 10 km/h mobility is assumed and a time window of T=3,600 seconds is simulated. From the results, it can be seen that when comparing the 8-zone solution with a first single-zone solution, the 8-zone solution achieves 5.7 dB improvement of the mean NMSE performance. When comparing the 8-zone solution with a second single-zone solution, in which the number of parameters and MPTR are similar, the 8-zone solution achieves an improved NMSE performance.

TABLE II
THE COMPREHENSIVE PERFORMANCE EVALUATION OF
THE THREE DIFFERENT FEEDBACK APPROACHES

| Method | Mean NMSE | MPTR | MPUR | FLOPs | Parameters |
|---|---|---|---|---|---|
| 1-zone (β = 16) | −18.6490 dB | 1184.16 param/s | 0 | 8.53M | 4.26M / 8.53M |
| 1-zone (β = 128) | −22.9270 dB | 9473.15 param/s | 0 | 68.22M | 34.10M / 68.21M |
| 8-zone (β = 16) | −24.3731 dB | 9473.28 param/s | 0.0147/s | 8.53M | 34.10M / 68.24M |

The zone-specific CSI feedback approach provides the advantage of fewer computations than the single-zone scenarios. By training the models on channel zones with reduced variations, the CSI feedback approach can leverage the underlying channel distribution. The MPTR and MPUR metrics characterize the overhead associated with the deep learning based CSI feedback approaches.

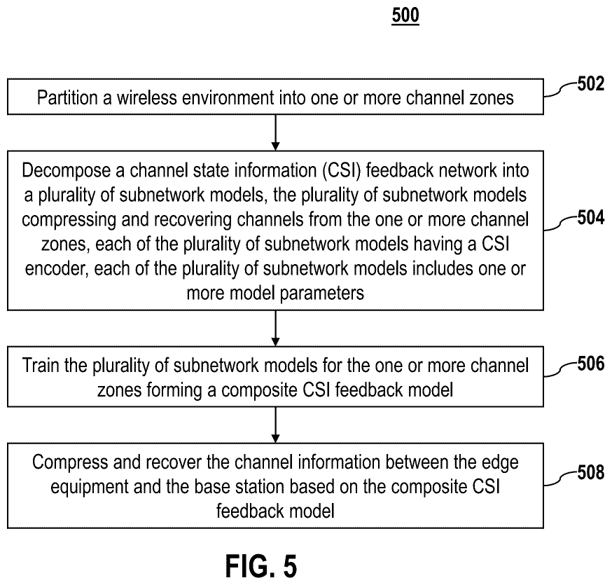

Referring now to FIG. 5, method 500 for compressing and recovering channel information between edge equipment and a base station includes, but is not limited to including, partitioning 502 a wireless environment into one or more channel zones, and decomposing 504 a channel state information (CSI) feedback network into a plurality of subnetwork models. The plurality of subnetwork models compress and recover channels from the one or more channel zones. Each of the plurality of subnetwork models has a CSI encoder, and each of the plurality of subnetwork models includes one or more model parameters. Method 500 also includes training 506 the plurality of subnetwork models for the one or more channel zones forming a composite CSI feedback model, and compressing and recovering 508 the channel information between the edge equipment and the base station based on the composite CSI feedback model.

The present disclosure has been described with reference to example implementations. Although a limited number of implementations have been shown and described, it will be appreciated by those skilled in the art that changes may be made in these implementations without departing from the principles and spirit of the preceding detailed description. It is intended that the present disclosure be construed as including such modifications and alterations insofar as they come within the scope of the appended claims or the equivalents thereof.

The foregoing description provides illustration and description, but is not intended to be exhaustive or to limit the possible implementations to the precise form disclosed. Modifications and variations are possible in light of the above disclosure or may be acquired from practice of the implementations.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

1. A method for compressing and recovering channel information between edge equipment and a base station, the method comprising:
partitioning a wireless environment into one or more channel zones;
decomposing a channel state information (CSI) feedback network into a plurality of subnetwork models, the plurality of subnetwork models compressing and recovering channels from the one or more channel zones, each of the plurality of subnetwork models having a CSI encoder, each of the plurality of subnetwork models includes one or more model parameters;
training the plurality of subnetwork models for the one or more channel zones forming a composite CSI feedback model; and
compressing and recovering the channel information between the edge equipment and the base station based on the composite CSI feedback model.

2. The method of claim 1, further comprising:
determining a position of the edge equipment;
collecting a downlink channel dataset; and
clustering the downlink channel dataset into the one or more channel zones based on the position.

3. The method of claim 1, further comprising:
determining a number of times the edge equipment switches from one of the one or more channel zones to another of the one or more channel zones within a pre-selected time interval;
computing model parameters transmission rate (MPTR) as an average rate that the one or more model parameters are downloaded per pre-selected period of time to the edge equipment;
computing model parameters update rate (MPUR) as a frequency that the edge equipment updates or switches the CSI encoder based at least on movement of the edge equipment; and
computing channel recovery error and feedback overhead based on a ratio of MPTR to MPUR.

4. The method of claim 1, wherein the training comprises:
jointly training the CSI encoder and a decoder.

5. The method of claim 1, wherein the training comprises:
training multiple of the CSI encoders per decoder.

6. The method of claim 1, wherein the training comprises:
training multiple decoders and the CSI encoders for the one or more channel zones.

7. The method of claim 1, wherein multiple of the one or more channel zones share a decoder or the CSI encoder.

8. The method of claim 1, wherein the one or more channel zones are non-overlapping.

9. The method of claim 1, further comprising:
accessing positions of the edge equipment from a network or cloud; and
clustering the edge equipment into the one or more channel zones based on the positions.

10. The method of claim 1, wherein the training comprises:
training the plurality of subnetwork models based on an end-to-end learning approach and a mean square error loss function.

11. The method of claim 1, wherein the one or more model parameters differ between each of the plurality of subnetwork models.

12. The method of claim 1, wherein the one or more channel zones comprises:
one or more clusters of scatterers.

13. The method of claim 1, wherein partitioning the wireless environment comprises:
clustering data about characteristics of edge equipment; and
partitioning the edge equipment into the one or more channel zones based at least on the characteristics.

14. The method of claim 13 wherein the characteristics comprise:
one or more of a position of the edge equipment, signal quality in the one or more channel zones, channel statistics in the one or more channel zones, or the wireless environment in the one or more channel zones.

15. The method of claim 1 wherein the edge equipment comprises cellular devices.

16. The method of claim 1 wherein the one or more channel zones comprise one or more spatial zones.

17. A computing system for compressing and recovering channel information between edge equipment and a base station comprising:
one or more processors; and
a memory system comprising one or more non-transitory computer-readable media storing instructions that, when executed by at least one of the one or more processors, cause the computing system to perform operations, the operations comprising:
partitioning a wireless environment into one or more channel zones;
decomposing a channel state information (CSI) feedback network into a plurality of subnetwork models, the plurality of subnetwork models compressing and recovering channels from the one or more channel zones, each of the plurality of subnetwork models having a CSI encoder, each of the plurality of subnetwork models includes one or more model parameters;
training the plurality of subnetwork models the one or more channel zones forming a composite CSI feedback model; and
compressing and recovering the channel information between the edge equipment and the base station based on the composite CSI feedback model.

18. The computing system of claim 17, wherein the operations further comprise:
determining a position of the edge equipment;
collecting a downlink channel dataset; and
clustering the downlink channel dataset into the one or more channel zones based on the position.

19. A non-transitory computer-readable medium storing instructions for compressing and recovering channel information between edge equipment and a base station that, when executed by one or more processors of a computing system, cause the computing system to perform operations, the operations comprising:
partitioning a wireless environment into one or more channel zones;
decomposing a channel state information (CSI) feedback network into a plurality of subnetwork models, the plurality of subnetwork models compressing and recovering channels from the one or more channel zones, each of the plurality of subnetwork models having a CSI encoder, each of the plurality of subnetwork models includes one or more model parameters;
training the plurality of subnetwork models the one or more channel zones forming a composite CSI feedback model; and
compressing and recovering the channel information between the edge equipment and the base station based on the composite CSI feedback model.

20. The non-transitory computer-readable medium of claim 19, wherein the operations further comprise:
determining a position of the edge equipment;
collecting a downlink channel dataset; and
clustering the downlink channel dataset into the one or more channel zones based on the position.
